(19) United States
(12) Patent Application Publication
(10) Pub. No.: US 2005/0211175 A1
(43) Pub. Date: Sep. 29, 2005

(54) Traveling pet bed

(76) Inventor: Tracy Johnson, Irving, TX (US)

Correspondence Address: STORM L.L.P., BANK OF AMERICA PLAZA, 901 MAIN STREET, SUITE 7100, DALLAS, TX, 75202, US

(21) Appl. No.: 10/800,446

(22) Filed: Mar. 15, 2004

(51) Int. Cl. A01K 29/00

(52) U.S. Cl. 119/28.5

(57) ABSTRACT

An improved portable or traveling pet bed has a generally laminar panel that is at least partially covered on one side with material adapted to be comfortable to a pet lying on the panel. At least one hinge member is formed in the panel and divides it into first and second portions on each side of the hinge member. The first and second portions of the panel can be folded toward one another into a closed position.

### BACKGROUND OF THE INVENTION

1. Field of the Invention

The present invention relates generally to beds for animals or pets. More particularly, the present invention relates to such beds that are particularly adapted to or suitable for use in travel.

2. Summary of the Prior Art

A number of challenges face pet owners who travel with their pets. Among the most readily apparent challenges is transportation of the pet, particularly in connection with air travel. Even after arrival, the pet owner is challenged with how to house the pet and make it comfortable at the travel destination. One concern is keeping the pet off of the host's furniture and bedding, and even to keep the pet from shedding on the host's carpet. At other destinations, the pet owner may simply wish to keep the pet off of the hotel bed or out of his or her own luggage, which often presents an irresistible lounging spot for the pet.

There are a number of “pet beds” commercially available that provide a “dedicated” spot for the pet to sleep and rest. These are not adapted for travel with the pet owner, however.

The need for portable or traveling pet beds is partially addressed in the prior art by U.S. Pat. No. 4,198,718 to Ballard; U.S. Pat. No. 6,516,745 to Spires et al.; D443,116 to Badler; and Des. 331,475 to Sineath. These disclose either “fully enclosed” (by a perimeter wall) pet beds, as in Ballard, or entirely flat pet beds, as in Spires, Badler, and Sineath. The fully enclosed bed is inherently limited by its size to use with pets of certain sizes. The flat bed provides no vertical surface against which a pet can “curl up” or rest its head and serves as nothing more than a mat upon which a pet may or may not lie.

Accordingly a need exists for a traveling or portable pet bed that provides a partial vertical wall against which the pet can “curl up,” while not acting as a constraint on the utility of the pet bed with pets of different sizes.

### SUMMARY OF THE INVENTION

It is a general object of the present invention to provide an improved portable or traveling pet bed. This and other objects of the present invention are achieved by providing a portable bed comprising a generally laminar panel that is at least partially covered on one side with material adapted to be comfortable to a pet lying on the panel. At least one hinge member is formed in the panel and divides it into first and second portions on each side of the hinge member. The first and second portions of the panel can be folded toward one another into a closed position.

An upstanding wall extends along the periphery of one of the portions of the panel, wherein, in an open position, the upstanding wall encloses only the first portion of the panel. In the closed position, the first and second portions of the panel and the upstanding wall define an enclosure in which items may be transported. At least one closure, preferably a zipper, is provided for securing the first and second portions of the panel in the closed position.

A handle or strap is provided for transporting the pet bed in the closed position. According to the preferred embodiment of the present invention, the panel is rigid and generally rectangular.

According to the preferred embodiment of the present invention, the panel is covered on the one side with a fleece material that is selectively removable from the panel for washing.

According to the preferred embodiment of the present invention, the panel comprises an upper panel, a lower panel, and a medial panel. All three panels are rigid. The upper panel is connected by a hinge to the medial panel, and the medial panel is connected by a hinge to the lower panel. The medial panel and the upstanding wall have approximately the same height or width.

Other objects, features, and advantages of the present invention will be apparent with reference to the drawings and detailed description of the invention, which follow.

### BRIEF DESCRIPTION OF THE DRAWINGS

FIG. 1 is a perspective view of the portable pet bed according to the present invention in a closed position.

FIG. 2 is an elevation view, partially in section, of the pet bed of FIG. 1 in an open position.

FIG. 3 is a plan view of the pet bed of FIGS. 1 and 2 in an open position.

FIG. 4 is another perspective of the pet bed of FIGS. 1 through 3 in the open position.

### DETAILED DESCRIPTION OF THE INVENTION

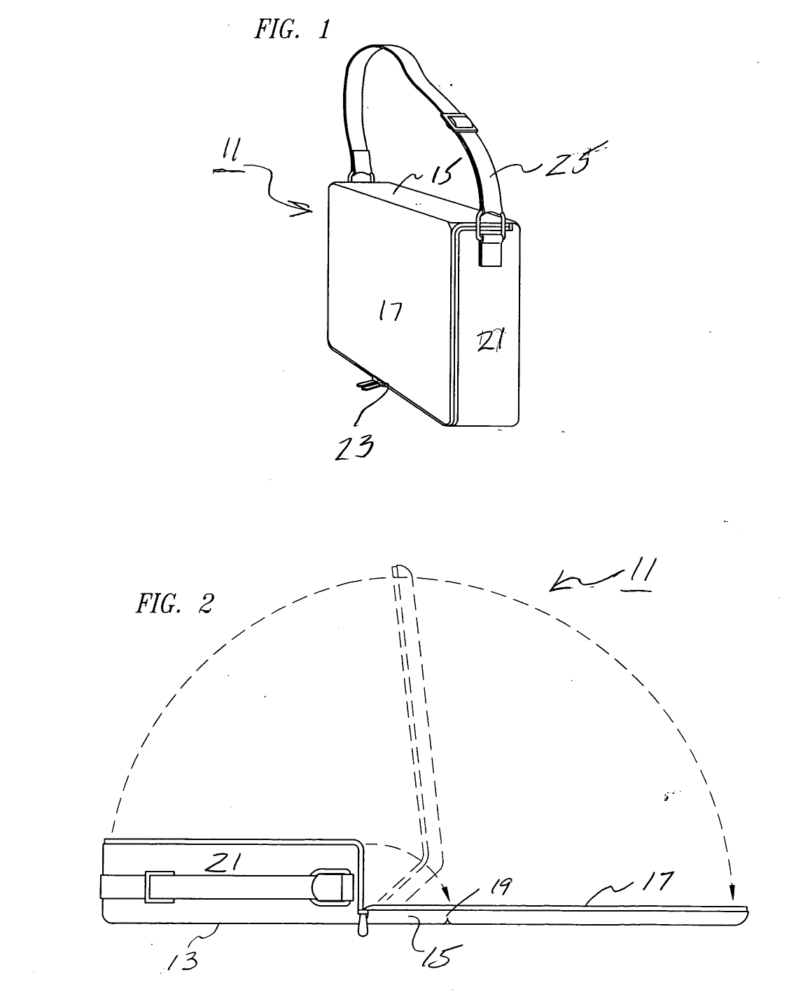

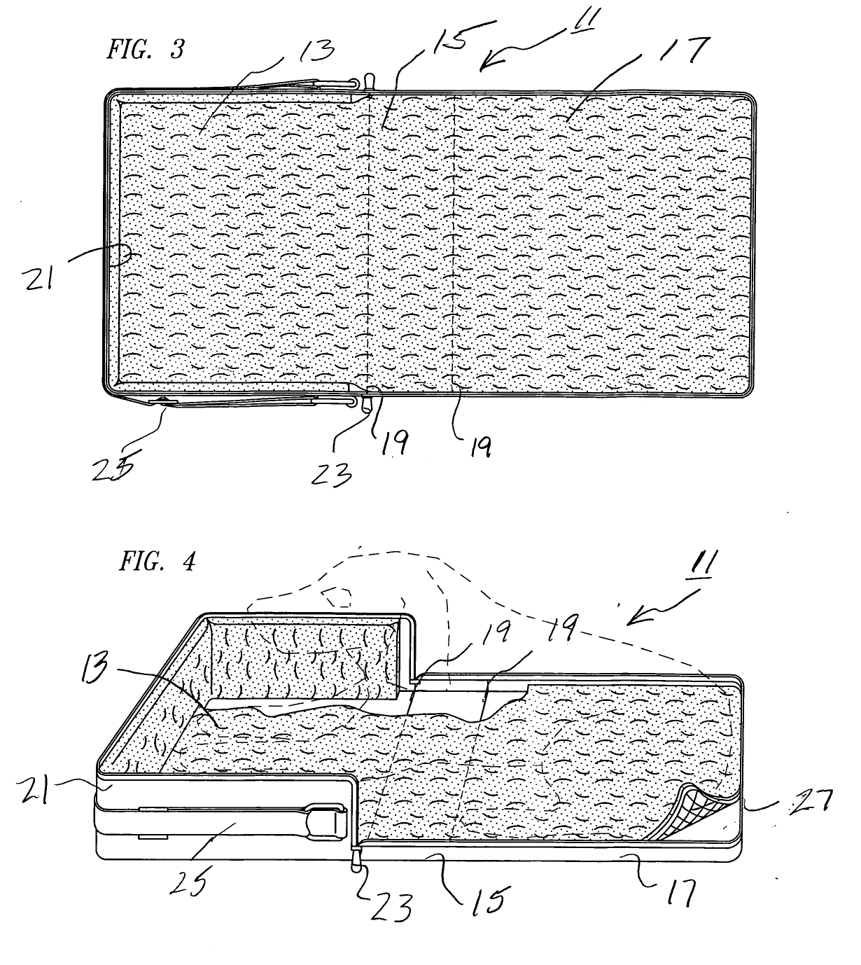

Referring now to the figures, and particularly to FIG. 1, a portable pet bed 11 according to the present invention is illustrated. FIG. 1 depicts the portable pet bed 11 in a closed position, while FIGS. 2, 3, and 4 depict pet bed 11 in the open position. As is illustrated in FIGS. 2, 3, and 4, pet bed 11 comprises a flat, laminar, generally rectangular panel, which is comprised of a first or lower panel 13, a medial panel 15, and a second or upper panel 17. Each panel preferably is rigid and formed of a plastic or masonite material, which may be covered on its outer surface (in the closed position as illustrated in FIG. 1) with vinyl, leather or similar durable but aesthetically appealing material. A fleece material is provided on the interior surface of panels (defined in the closed position of FIG. 1) and is underlaid with padding that is adapted to be comfortable for a pet (a dog or cat, for instance) to lie upon.

Upper and lower panels 13, 17 are rectangular in configuration, the same size, and connected along long edges thereof to the long edges of third or medial panel 15 with conventional “piano” or luggage hinges 19. The configuration of the hinge or hinge member 19 is not as important as the ability to permit upper and lower panels 13, 17 to fold toward one another into the closed position illustrated in FIG. 1.

An upstanding wall 21 is formed on three of the edges (the periphery) of lower panel 13 and is approximately the same width or height as medial panel 15. Upstanding wall 21 provides a partial enclosure over approximately half of pet bed 11 in the open position. This provides a wall or vertical surface (in the open position of FIGS. 2, 3, and 4) against which a pet may rest its head or “curl up.” Additionally, upstanding wall 21 cooperates with lower panel 13, medial panel 15, and upper panel 17 in the closed position to define an enclosure in which items may be stored and transported. Such items may include pet food dishes, chew toys, and other pet accessories.

Pet bed 11 is maintained in the closed position by a closure 23, preferably a zipper that extends along the periphery of medial panel 15 and upper panel 17, as well as upstanding wall 21. Closure 23 thus both maintains the pet bed 11 in the closed position and closes or seals the interior of the pet bed. An adjustable carry strap or handle 25 is secured to the exterior of upstanding wall 21 to provide a carrying means for pet bed 11. The interior surface of pet bed 11 is covered in a padded fleece 27, which is secured to panels 13, 15, and 17 by Velcro, snaps, a zipper, or other means so that the fleece and padding may be removed and washed or otherwise cleaned.

In operation, pet bed 11 according to the present invention can be maintained in either a closed position (FIG. 1) for transportation or in an open position (FIGS. 2-4) in which panels 13, 15, 17 are in a generally coplanar relationship. In the open position, the panels provide a comfortable surface on which an animal may lie that protects the bed, carpet, furniture, and other luggage from pet fur and dander. Upstanding wall 21 provides a partial enclosure for the animal to curl up against or rest its head on or against. Those portions of panels 13, 15, 17 that are not enclosed by upstanding wall 21 are unobstructed at their edge, allowing the animal freedom of ingress and egress. The partial enclosure of upstanding wall also renders pet bed 11 useful with animals of differing size.

The invention has been described with reference to a preferred embodiment thereof. It is thus not limited, but is susceptible to variation and modification without departing from the scope of the invention.

1. A portable pet bed comprising:
a generally laminar panel at least partially covered on one side with material adapted to be comfortable to a pet lying on the laminar panel;
a hinge formed in the laminar panel and dividing the panel into first and second portions on each side of the hinge, wherein the first and second portions can be folded toward one another into a closed position;
an upstanding wall extending along a periphery of one of the portions of the laminar panel and proximal the hinge, wherein, in an open position, the upstanding wall encloses only the portion of the panel from which it extends and, in the closed position, the first and second portions of the panel and the upstanding wall define an enclosure in which items may be transported;
at least one closure for securing the first and second portions of the panel in the closed position; and
a handle for transporting the pet bed with the panels in the closed position.

2. The portable pet bed according to claim 1, wherein the panel is rigid and generally rectangular.

3. The portable pet bed according to claim 1, wherein the panel is covered on the one side with fleece that is selectively removable from the panel.

4. The portable pet bed according to claim 1, wherein the closure comprises a zipper.

5. A portable pet bed comprising:
a first panel having a periphery;
a second panel of generally the same size as the first panel;
a hinge member coupling the first and second panels, wherein the first panel and second panel can be folded toward one another into a closed position;
an upstanding wall extending along the periphery of the first panel, wherein, in the closed position, the first and second panels and and the upstanding wall define an enclosure in which items may be transported and, in an open position, the first and second panels lie in a generally coplanar relationship and only the first panel is bounded by the upstanding wall;
at least one closure for securing the first and second panels in the closed position; and
a handle for transporting the pet bed with the panels in the closed position.

6. The portable pet bed according to claim 5, wherein each of the first and second panels is rigid and generally rectangular and has a pair of long edges and a pair of short edges.

7. The portable pet bed according to claim 6, wherein the hinge member connects one long edge of the first panel to one long edge of the second panel.

8. The portable pet bed according to claim 7, wherein the upstanding wall extends along the long edge of the first panel opposite the hinge member and along the two short edges of the first panel.

9. The portable pet bed according to claim 7, wherein the handle is disposed on the portion of the upstanding wall extending along the long edge of the first panel.

10. The portable pet bed according to claim 7, wherein the closure comprises a zipper disposed between the edge of the second panel and the upstanding wall.

11. The portable pet bed according to claim 5, wherein the panels are covered on one side with fleece that is selectively removable from the panel.

12. A portable pet bed comprising:
an upper generally rigid and laminar rectangular panel;
a lower generally rigid and laminar rectangular panel;
a medial rigid and laminar rectangular panel;
an upstanding wall extending about three of the sides of the lower panel at the edges thereof, the upstanding wall having a height approximately equal to the width of the medial panel;
a pair of hinges, each hinge connecting a long edge of the medial panel to long edges of the upper and lower panels, wherein the upper and lower panels are movable about the hinges from an open position in which the upper and lower panels are generally coplanar with the medial panel, and a closed position in which the upper panel abuts the upstanding wall and an enclosure is defined within the upstanding wall, upper panel, lower panel, and medial panel;
a closure for securing the panels in the closed position; and
a handle for transporting the pet bed in the closed position.

13. The pet bed according to claim 12, wherein the upper, lower, and medial panels are covered on one side with a fabric material adapted to provided a comfortable surface for the pet to lie upon when the pet bed is in the open position.

14. The pet bed according to claim 12, wherein the closure is a zipper that secures the periphery of the upper panel to the periphery of the upstanding wall.

15. The portable pet bed according to claim 13, wherein the fabric material is fleece that is selectively removable from the panel.
